(19) United States
(12) Patent Application Publication
(10) Pub. No.: US 2005/0055514 A1
(43) Pub. Date: Mar. 10, 2005

(54) Data rearrangement method

(76) Inventor: Junichi Tamura, Tokyo (JP)

Correspondence Address: RABIN & Berdo, PC, 1101 14TH STREET, NW, SUITE 500, WASHINGTON, DC, 20005, US

(21) Appl. No.: 10/733,302

(22) Filed: Dec. 12, 2003

(30) Foreign Application Priority Data
Sep. 10, 2003 (JP) 318493/2003

(51) Int. Cl. G06F 12/00

(52) U.S. Cl. 711/154

(57) ABSTRACT

There is provided an efficient data rearrangement method which reduces the number of processing operations to shorten processing time, and deals with optional rules. The method includes: a) storing data in a first data storage section; b) storing data rearrangement information in a stack; and c) reading the data stored in the first data storage section, and storing the data in a second data storage section based on the data rearrangement information stored in the stack.

### BACKGROUND OF THE INVENTION

1. Field of the Invention

The present invention relates to a data processing method in digital communications or digital signal processing, and more particularly, it relates to a data rearrangement method.

This application is counterpart of Japanese patent application, Serial Number 318493/2003, filed Sep. 10, 2003, the subject matter of which is incorporated herein by reference.

2. Description of the Relater Art

An interleaving process is carried out in a field of digital communications or digital signal processing. The interleaving process performs operations such as reading, writing, and transmission/reception by rearranging data divided into a plurality of groups in accordance with a specific rule.

For example, in the interleaving process at a digital signal processor (processor for processing digital signals, referred to as “DSP” hereinafter), an order of data to be processed by the DSP may be different from that of data written in a memory. Rearrangement of data used by the DSP in a processing order requires much processing time and a large memory capacity.

Among conventional methods for rearranging data, there is a method which uses an address conversion table. To simplify explanation, one-dimensional rearrangement will be described here. FIG. 8 is a view showing a data arrangement state before/after data rearrangement and a state of an address conversion table in order to explain a conventional data rearrangement method which uses the address conversion table. In FIG. 8, “ADDRESS: 0x0000” or the like represents an address in a hexadecimal form of a memory, and A to E denote data of predetermined lengths stored in the memory and rearranged to be processed.

As shown in FIG. 8, in the memory, five data are stored in an order of A, B, C, D, and E from an address (0x0000) to an address (0x0004). An order of data rearrangement is stored in “ADDRESS CONVERSION TABLE” from an address (0x2000) to an address (0x2004). In accordance with rearrangement rules (1) to (5) stored in the address conversion table, the data A, B, C, D and E are rearranged in storage places of an address (0x1000) to an address (0x1004) in an order of D, B, E, A and C (FIG. 8).

FIG. 9 shows a flowchart and a program example for realizing the aforementioned conventional rearrangement method. In this case, three address storage registers r0, r1, r2 and one data storage register a0 are used. In the program example, “mov” is a command for copying a value of a left of “,” to a value of a right of “,”, a character/numeral in “( )” denotes a value of data stored in its address or register, and a character/numeral without “( )” denotes an address or a register itself. “+” on the right of a character/numeral indicates incrementing of a value by +1.

In FIG. 9, first, in S1, a first address (0x2000) of the address conversion table is set to the r0 register (S1). Then, in S2, a first address (0x0000) to store data before rearrangement is set to the r1 register (S2). Then, in S3, data A stored in the address (0x0000) of a memory (I) stored in the r1 register is set to the a1 register, and a value of the r1 register is incremented (+1) (S3). Then, in S4, an address value stored in the address of the r0 register is set to the r2 register, and a value of the r0 register is incremented (+1) (S4). Then, in S5, a data value stored in the a0 register is set to an address stored in the r2 register (S5).

If the operations of S3 to S5 are repeated five times, the data stored in the addresses (0x0000) to (0x0004) before rearrangement are rearranged in accordance with the address conversion table from (0x2000) to (0x2004), and these data are stored in addresses (0x1000) to (0x1004) (FIG. 9).

Patent Document 1: Japanese Patent Application Laid-Open No. 2001-196940

### SUMMARY OF THE INVENTION

Such a conventional rearrangement method has problems that much processing is necessary and a large memory capacity is necessary.

The present invention has been made in view of the foregoing problems of the conventional data rearrangement method, and an object of the invention is to provide an efficient data rearrangement method which can reduce the number of processing operations (the number of commands) to shorten processing time, and which can be realized by a small memory capacity.

In order to achieve the object, a data rearrangement method of the present invention comprises: a) a step of storing data in a first data storage section; b) a step of storing data rearrangement information in a stack; and c) a step of reading the data stored in the first data storage section, and storing the data in a second data storage section based on the data rearrangement information stored in the stack.

According to such a method, it is possible to realize efficient data rearrangement by reducing the number of processing operations to shorten processing time and by a small memory capacity. Moreover, rearrangement can be carried out by optional rules.

The data rearrangement information may contain an address of the second data storage section. The first data storage section may be a register, and the second data storage section may be a random access memory. Results of rearrangement may be sequentially stored in a memory, or results of arithmetic operations by a DSP.

The reading and the storing may be carried out by using an address conversion table and a corresponding stack pointer. A plurality of address conversion tables and a plurality of corresponding stack pointers may be used. By subjecting storage of results of the reading, rearrangement or arithmetic operations to pipeline processing, a processing speed can be further increased.

Further inclusion of a step of calculating OR or ADD of a read address and an offset register enables rearrangement of a plurality of data rows. Especially, use of an OR operation is effective for reducing address space to be used, and use of an ADD operation is effective for meticulously using the address space.

Furthermore, a rearrangement only register can be used in place of the stack pointer. The use of the rearrangement only register enables updating of an optional pointer, and thus it is possible to carry out more efficient data rearrangement.

### BRIEF DESCRIPTION OF THE DRAWINGS

FIG. 1 is an explanatory view showing a state of an address conversion table and a position of a stack pointer according to a first embodiment;

FIG. 2 is an explanatory view showing a flowchart for realizing a rearrangement method of the first embodiment, and a program example;

FIG. 3 is an explanatory view showing a stage table in the case of pipeline processing according to the first embodiment;

FIG. 4 is an explanatory view showing a state of an address conversion table and contents of a rearrangement only register (rr) according to a third embodiment;

FIG. 5 is an explanatory view showing a flowchart for realizing a rearrangement method of the third embodiment, and a program example;

FIG. 6 is an explanatory view showing a state of an address conversion table, a position of a stack pointer, and functions of a control register 40 and an offset register 50 according to a fourth embodiment;

FIG. 7 is an explanatory view showing a byte-writing signal according to the fourth embodiment;

FIG. 8 is an explanatory view showing a data arrangement state before/after data rearrangement and a state of an address conversion table in order to explain a conventional data rearrangement method; and

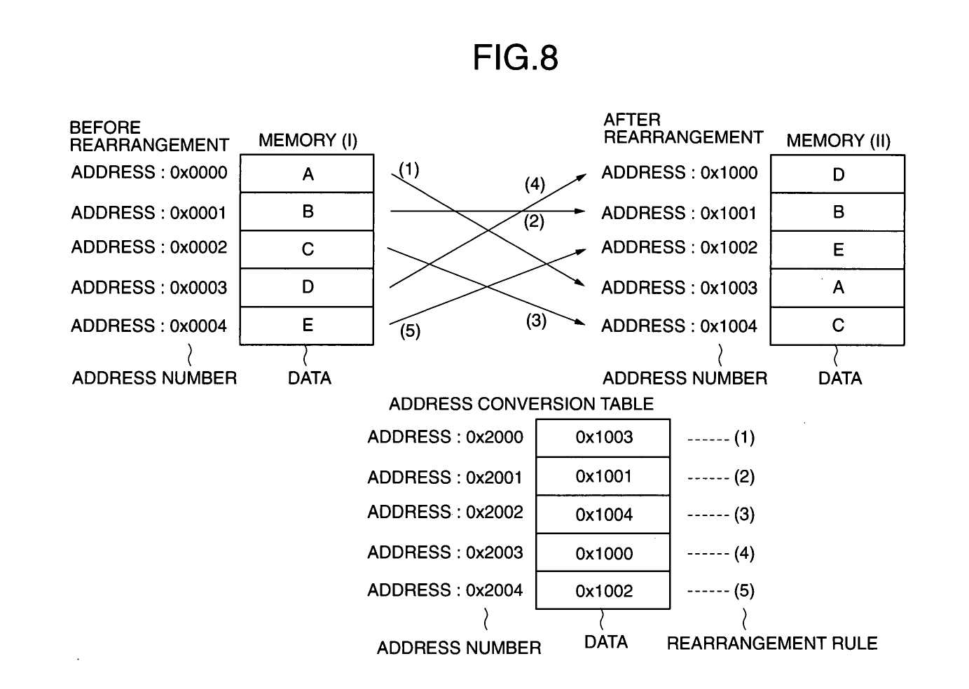

FIG. 9 is an explanatory view showing a flowchart for realizing the conventional rearrangement method, and a program example.

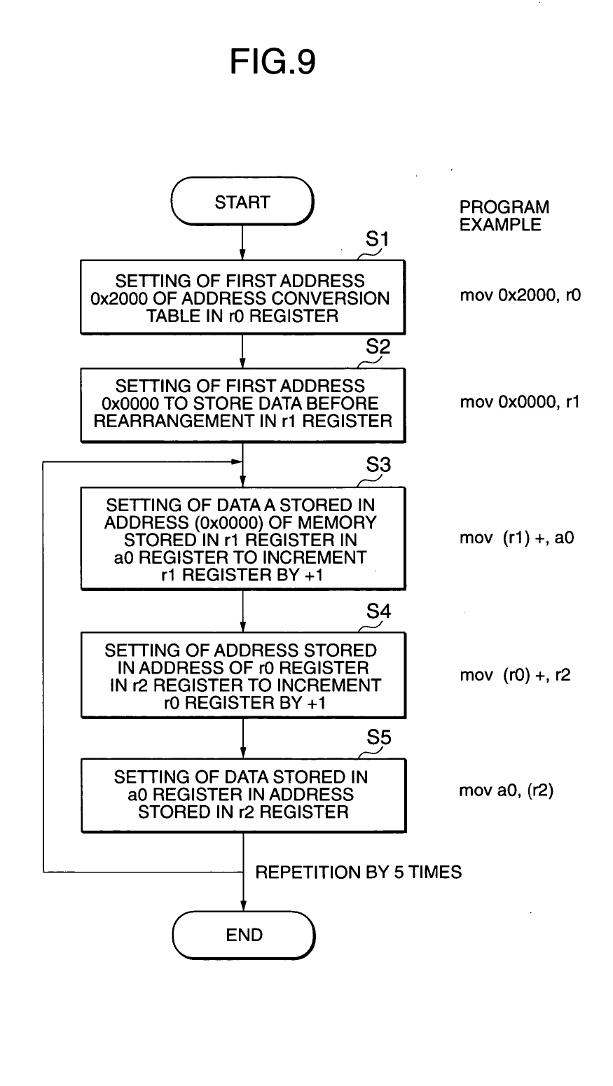

### DETAILED DESCRIPTION OF THE PREFERRED EMBODIMENTS

Next, detailed description will be made of the preferred embodiments of data rearrangement methods of the present invention with reference to the accompanying drawings. In the specification and the drawings, components having substantially similar functions will be denoted by similar reference numerals, and repeated explanation will be omitted.

(First Embodiment)

A data rearrangement method of the first embodiment includes a step of storing a specific rule in an address conversion table, and a step of sequentially reading addresses to store data for an arithmetic operation from the address conversion table by using a stack pointer. One-dimensional rearrangement will be described here in order to simplify explanation, but the invention is not limited to this rearrangement.

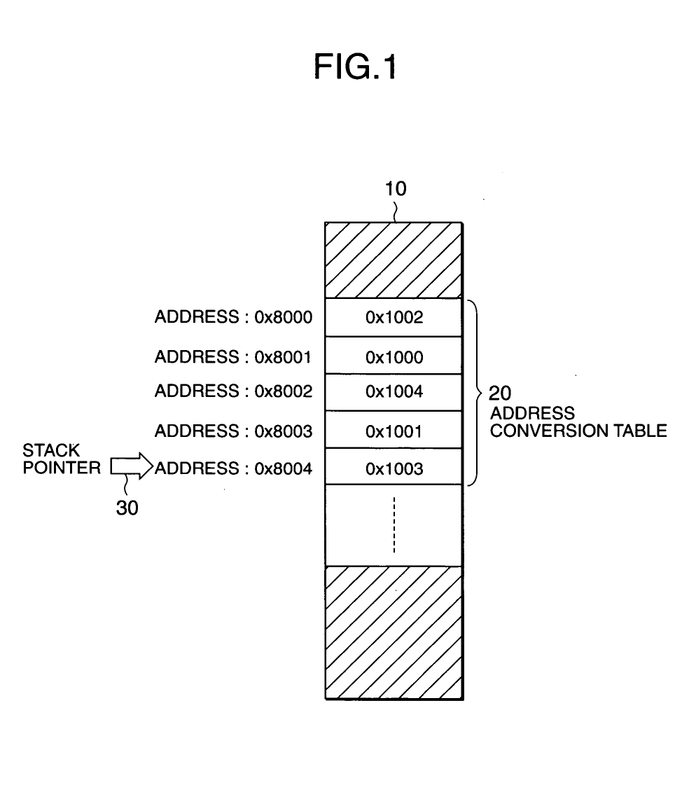

FIG. 1 is a view showing a state of the address conversion table and a position of the stack pointer in order to explain the data rearrangement method of the first embodiment which uses the address conversion table and the stack pointer. The stack pointer is a resister for holding a first address of the stack. It is generally incremented (+1) when data is pushed down (stored), and decremented (−1) when data is popped up (read). The stack employs a last-in-first-out (LIFO) structure in which first stored data is read.

In FIG. 1, “ADDRESS: 0x8000” or the like represents an address in a hexadecimal form of a memory. First, information of rearrangement is pushed down in the stack to be stored as an address conversion table. Addresses are sequentially stored: for example, an address (0x1002) is stored in an address (0x8000) of a memory 10, an address (0x1000) is stored in an address (0x8001) of the memory 10 and so on.

In the case of carrying out a sequential arithmetic operation by a DSP, the stack is popped up to refer to an address (0x1003) stored in an address (0x8004) indicated by the stack pointer, and data is read to be stored in the address (0x1003) of the memory 10. After completion of the data arithmetic operation by the DSP, since a stack pointer 30 has been decremented by popping-up, an address (0x8003) is indicated this time, and reference is made to an address (0x1001) to be stored here. Similarly thereafter, reference is made to the address conversion table (FIG. 1).

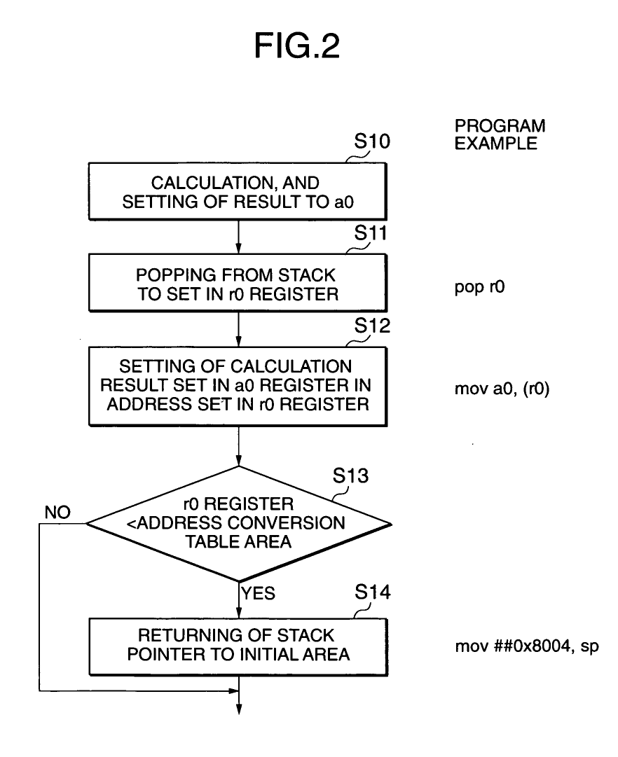

FIG. 2 shows a flowchart for realizing the rearrangement method of the first embodiment, and a program example. The flowchart and the program example of FIG. 2 show a process after a conversion address is first stored in the address conversion table (stack), and then the stack pointer moves to a predetermined pointer position. Here, a one address storage register r0 and a one data storage register a0 are used. In the program example, “pop” is a command for copying a value of a first address of the stack to a right register, “mov” is as previously described, a character/numeral in “( )” indicates a value of data stored in its address or register, and a character/numeral without “( )” indicates an address value or a register itself.

First, in S10, the DSP starts an arithmetic operation, and its result is stored in the a0 register (S10). Then, in S11, the stack is popped up, and an address (0x1003) to be stored in an address (0x8004) of the address conversion table indicated by the stack pointer is set to the r0 register (S11). Then, in S12, the result of the arithmetic operation stored in the a0 register is stored in the address (0x1003) stored in the r0 register (S12). Then, in S13, determination is made as so removal of the r0 register from an address conversion table area (S13). If a result of the determination shows the removal from the area, the stack pointer is returned to an initial area. If no removal is determined, the process proceeds to a next arithmetic operation (FIG. 2). If the stack pointer is returned to an initial state at a break point of the arithmetic operation, the steps S13, S14 can be omitted.

After the movement of the stack pointer from the address (0x8004) to an address (0x8000), an arithmetic operation is executed in an order pushed down beforehand in the stack.

As described above, by using the stack pointer, data can be written in a predetermined address by a small number of processing operations. Additionally, since optional rearrangement information can be written in the stack, optional rearrangement can be dealt with. These operations are difficult if a process is carried out only by hardware.

The storage (writing) of data has been described. However, data reading can also be realized by a similar method. In this case, the program example of FIG. 2 becomes as follows:
pop r0
mov (r0), a0

In the program example of FIG. 2, the pop command and the mov command are separately executed. However, in a system which can execute a pop command and a mov command in one command, they can be executed by one command.

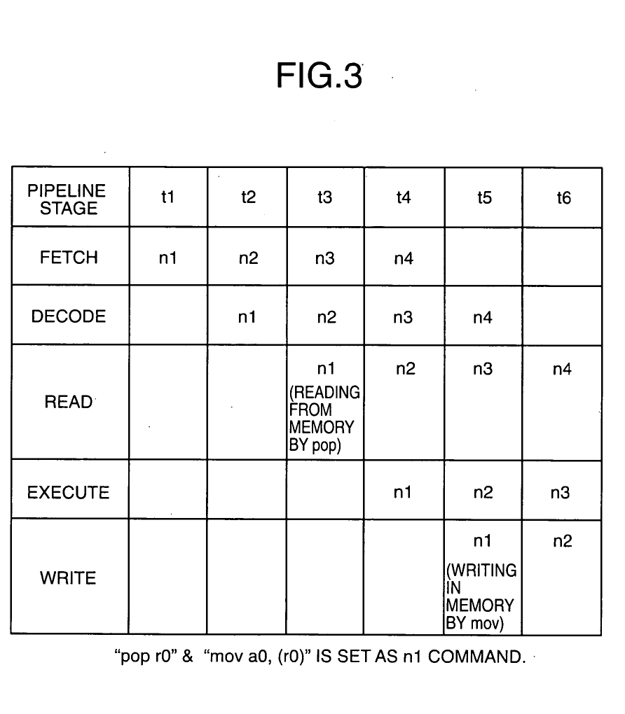

In the program example of FIG. 2, the reading is carried out from the memory by the pop command, while the writing in the memory is carried out by the mov command. However, in the case of a system in which memory reading and memory writing are at separate stages, these operations are subjected to pipeline processing to enable execution by one command. An example is shown in FIG. 3.

In the case of rearrangement during data reading shown in FIG. 3, if “pop r0” and “mov (r0), a0” are in one command, reading is carried out from the memory by the pop command, and reading is also carried out from the memory by the mov command. Accordingly, competition occurs at Read of a state t3. However, in the case of a system which avoids competition, even data reading can be executed by one command. As measures to avoid competition, when simultaneous reading operations occur, one reading is preferentially executed, and the other reading is executed later. This way, competition avoidance may be realized. In the case of reading from an independent memory, since no competition occurs, the operation can be executed by one command.

The first embodiment has been described by way of case in which there is only one stack area. However, in the case of using a plurality of bits of rearrangement information, a plurality of stack pointers may be prepared to process a plurality of stacks. In such a case, pluralities of push commands for operating the stacks, pop commands, and mov commands to the stack pointers for “INITIALIZE STACK POINTER” are prepared.

(Second Embodiment)

A data rearrangement method of a second embodiment further comprises, in addition to those of the method of the first embodiment, a step of calculating OR or ADD of a read address and an offset register.

The offset address is disposed, a low-order bit of a rearrangement address is stored in a stack, and OR or ADD of a read address and the offset register is calculated to generate a rearrangement address. Accordingly, a plurality of data rows can be rearranged.

In this case, the “OR” calculation means an “or” calculation for each bit, and the “ADD” calculation means an addition” calculation. Selection of “OR” or “ADD” may be optionally controlled by disposing e.g., a control register.

According to the second embodiment, rearrangement of a plurality of data rows is enabled in addition to the effects provided by the first embodiment.

(Third Embodiment)

According to a data rearrangement method of a third embodiment, a rearrangement only register is used in place of the stack pointer of the first embodiment. The use of the rearrangement only register enables updating of an optional pointer, and thus it is possible to carry out more efficient data rearrangement.

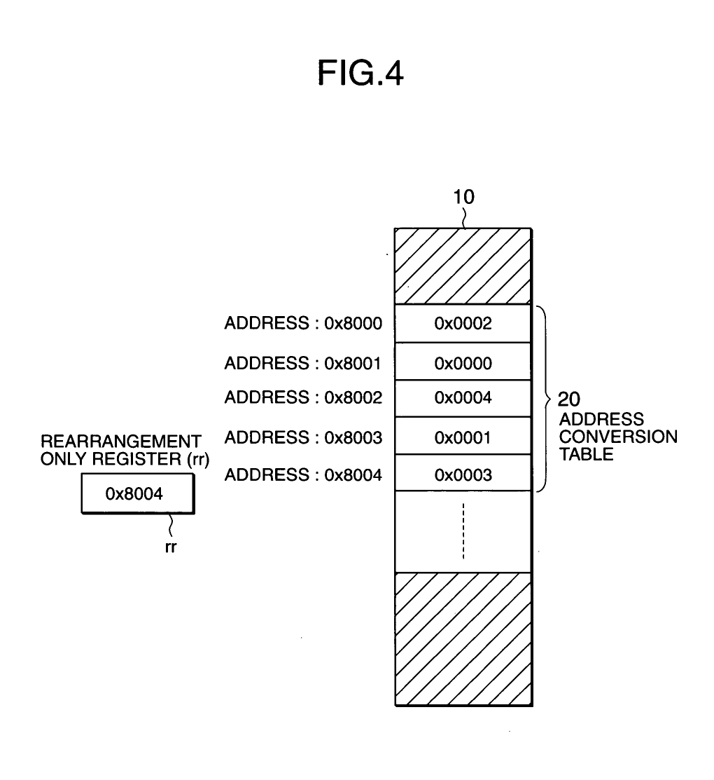

FIG. 4 is a view showing a state of an address conversion table and contents of a rearrangement only register (rr) in order to explain the data rearrangement method of the third embodiment which uses the address conversion table and the rearrangement only register (rr).

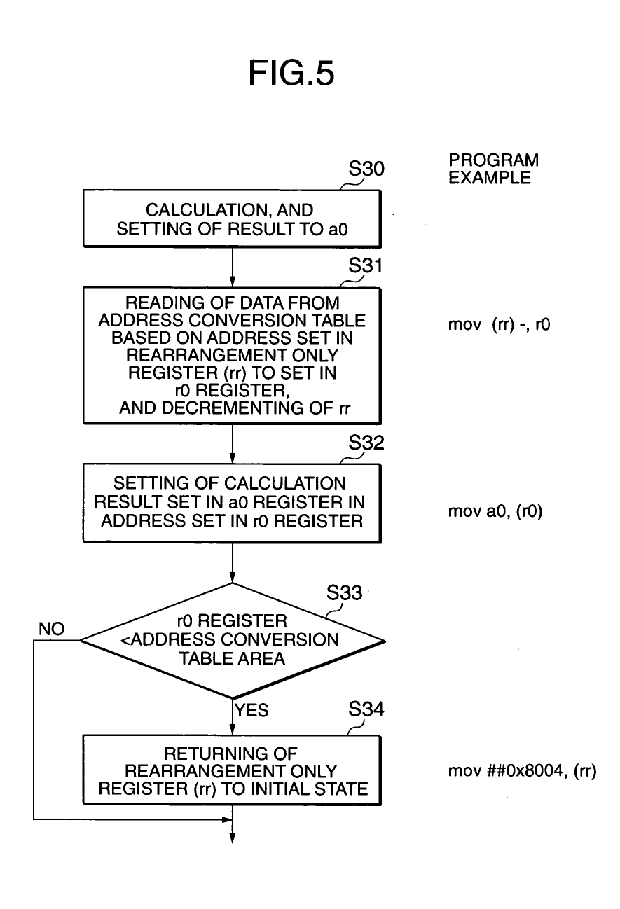

FIG. 5 shows a flowchart for realizing the rearrangement method of the third embodiment, and a program example. The flowchart and the program example of FIG. 5 show a process after a state in which a conversion address is first stored in the address conversion table, and a predetermined pointer initial value is stored in the rearrangement only register rr. Here, in addition to the rearrangement only register rr, a one address storage register r0 and a one data storage register a0 are used. In the program example, “mov” or the like is as-previously described.

First, in S30, a DSP starts an arithmetic operation, and its result is stored in the a0 register (S30). Then, in S31, an address (0x0003) to be stored in an address (0x8004) of the address conversion table indicated by an address value stored in the rearrangement only register rr is read, set to the r0 register, and the rearrangement only register rr is decremented (−1) (S31). Then, in S32, the result of the arithmetic operation stored in the a0 register is stored in the address (0x0003) stored in the r0 register (S32). Then, in S33, determination is made as so removal of the r0 register from an address conversion table area (S33). If a result of the determination shows the removal from the area, the rearrangement only register rr is returned to an initial area. If no removal is determined, the process proceeds to a next arithmetic operation (FIG. 5).

After the contents of the rearrangement only register rr are changed from the address (0x8004) to an address (0x8000), an arithmetic operation is executed in an order prestored in the memory.

According to the third embodiment, effects similar to those of the first embodiment can be obtained. In the foregoing, the rearrangement only register rr is decremented by −1 when the data is read from the rearrangement only register rr. However, modifications can be optionally made in accordance with purposes. For example, optional + or −, module addressing etc., can be cited as modifications. For a modification, a register which supports all types of addressing disposed in a general register can be used. In the case of the module addressing, as in the case of the rearrangement only register, a register only for specifying a module width may be prepared, and necessary registers may also be prepared for other types of addressing. Thus, the use of the module addressing eliminates a necessity of periodical resetting of the pointer to enable efficient rearrangement.

(Fourth Embodiment)

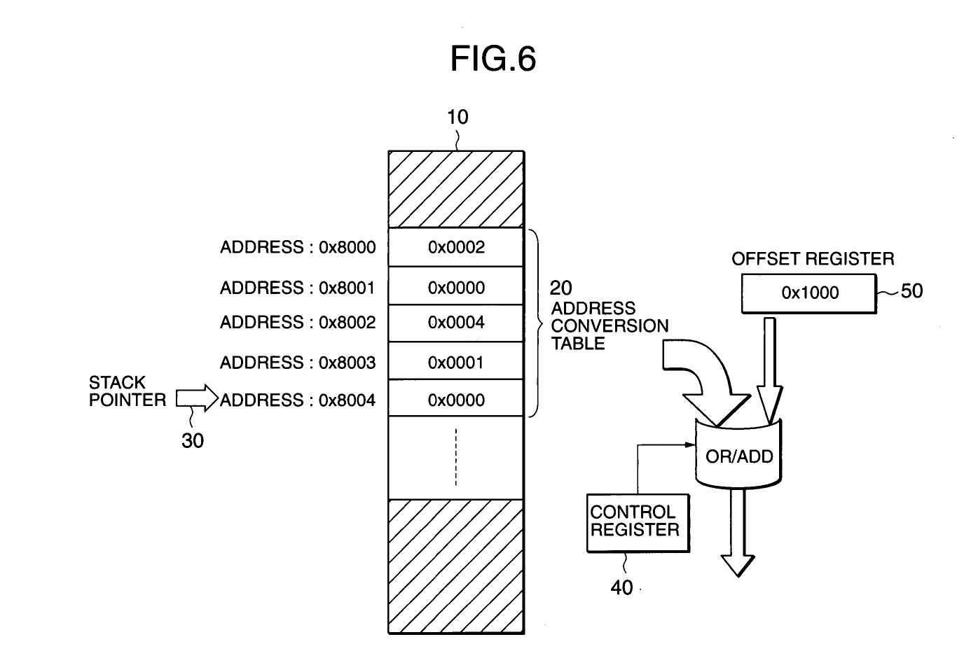

According to a data rearrangement method of a fourth embodiment, data stored in an address conversion table contains byte-writing information. FIG. 6 is a view showing a state of the address conversion table, a position of a stack pointer, and functions of a control register 40 and an offset register 50 according to the fourth embodiment. According to the first to third embodiments, the data writing is carried out with respect to a fixed bit length (e.g., 32 bits). However, depending on an arithmetic operation, it is necessary to execute writing with respect to only optional bits (e.g., 8 bits) of 32 bits.

According to the fourth embodiment, when rearrangement information is stored in the address conversion table, a low-order bit is set as a byte-writing control bit to enable writing in an optional place.

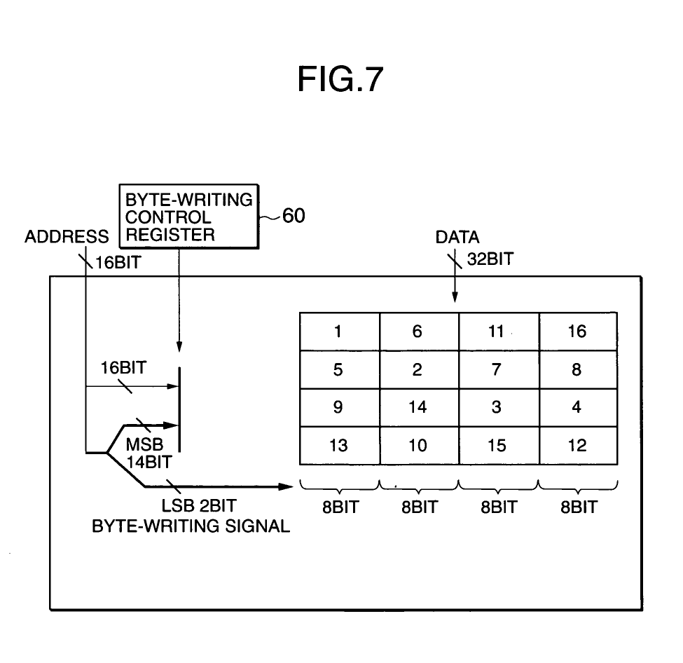

For example, as shown in Table 1, FIG. 7, low-order 2 bits of rearrangement information are set as byte-writing information.

TABLE 1

| Byte-writing information | Meaning |
|---|---|
| 00 | Write for bit 7 to 0 |
| 01 | Write for bit 15 to 8 |
| 10 | Write for bit 23 to 16 |
| 11 | Write for bit 31 to 24 |

Further, a byte-writing control register is disposed and, if byte-writing is permitted, low-order 2 bits of an address are supplied as byte-writing information to a memory. Remaining high-order 14 bits are supplied as addresses to the memory (see FIG. 7).

Thus, according to the fourth embodiment, the setting of the low-order bit of the rearrangement information enables writing only in a predetermined bit. In the aforementioned example, 32 bits are divided into 8 bits. However, a way of division is not limited to this. When division is made, the number of bits of the byte-writing information may be set to a necessary number of bits. Additionally, by installing the byte-writing control register, the memory used for rearrangement can also be used for general purposes.

The preferred embodiments of the data rearrangement methods of the present invention have been described with reference to the accompanying drawings. However, the invention is not limited to the embodiments. It is apparent to those skilled in the art that various changes and modifications can be made within a scope of technical ideas specified in appended claims and, needless to say, such changes and modifications are also within the technical scope of the invention.

For example, the invention can be applied to multidimensional rearrangement.

The present invention relates to the digital processing method in digital communications or digital signal processing, and it can be applied especially to the data rearrangement method.

As described above, according to the present invention, there can be provided a data rearrangement method which can reduce the number of processing operations (the number of commands) to shorten processing time more than the conventional method, which can be realized efficiently by a small memory capacity, and which can deal with optional rearrangement rules.

1. A method for rearranging data comprising the steps of:
a) storing data in a first data storage section;
b) storing data rearrangement information in a stack; and
c) reading the data stored in the first data storage section, and storing the data in a second data storage section based on the data rearrangement information stored in the stack.

2. The method according to claim 1,
wherein the data rearrangement information contains an address of the second data storage section.

3. The method according to claim 2,
wherein the first data storage section is a register; and
the second data storage section is a random access memory.

4. A method for rearranging data comprising the steps of:
a) storing a plurality of data in a first data storage section;
b) storing data rearrangement information in a stack; and
c) reading the plurality of data stored in the first data storage section in an order based on the data rearrangement information stored in the stack, and storing the data in a second data storage section.

5. The method according to claim 4,
wherein the data rearrangement information contains an address of the second data storage section.

6. The method according to claim 5,
wherein the first data storage section is a random access memory; and
the second data storage section is a register.

7. The method according to claim 5,
wherein the first data storage section and the second data storage section are random access memories.

8. A method for rearranging data comprising the steps of:
a) storing a plurality of data in a first data storage section;
b) storing data rearrangement information in a stack; and
c) reading the plurality of data stored in the first data storage section, and storing the data in a second data storage section based on the data rearrangement information stored in the stack.

9. The method according to claim 8,
wherein the data rearrangement information contains an address of the second data storage section.

10. The method according to claim 9,
wherein the first data storage section and the second data storage section are random access memories.

11. The method according to claim 1,
wherein the reading and the storing are carried out by using an address conversion table and a corresponding stack pointer.

12. The method according to claim 1, further comprising:
calculating logic OR operation or logic ADD operation of a read address and an offset register.

13. The method according to claim 11, wherein the reading and the storing are carried out by using a registor substituted for the stack pointer.

14. The method according to claim 11, wherein the data stored in the address conversion table includes byte write information.
